(19) United States
(12) Patent Application Publication
(10) Pub. No.: US 2004/0209074 A1
(43) Pub. Date: Oct. 21, 2004

(54) Mat faced gypsum board

(75) Inventors: Brian G. Randall, Lawrenceville, GA (US); Russell S. Smith, Covington, GA (US)

Correspondence Address: BANNER & WITCOFF, 1001 G STREET N W, SUITE 1100, WASHINGTON, DC, 20001, US

(73) Assignee: Georgia-Pacific Gypsum Corporation, Atlanta, GA

(21) Appl. No.: 10/417,344

(22) Filed: Apr. 17, 2003

(51) Int. Cl. B32B 1/00

(52) U.S. Cl. 428/341; 156/42; 428/325

(57) ABSTRACT

A moisture-tolerant structural panel comprising a gypsum board which comprises a set gypsum core sandwiched between and faced with fibrous mats, wherein a free surface of one of said mats is pre-coated with a combination of a mineral pigment, optionally an inorganic adhesive binder and a hydrophobic, UV resistant polymer latex adhesive binder applied to said surface as an aqueous coating composition, said aqueous coating composition upon drying and setting, covering said mat to the extent that substantially none of the fibers of said mat can be seen protruding from said coating.

### FIELD OF THE INVENTION

This invention relates to an improved fibrous mat-faced gypsum board, for example, a gypsum board faced with glass fiber mat. More particularly, the present invention relates to a fibrous mat-faced gypsum board that is prepared with a pre-coated fibrous mat. The coating on the pre-coated mat comprises a dried aqueous mixture of a mineral pigment or filler, an organic binder comprised of a hydrophobic, UV-resistant polymer latex adhesive; and, optionally a second binder comprised of an inorganic adhesive.

The present invention is particularly advantageous for use in exterior applications in which the fibrous mat-faced gypsum board is expected to be exposed both to UV rays and to a high humidity or high moisture environment during installation or use. Still other applications and uses will become apparent from the detailed description of the invention, which appears hereinafter.

### BACKGROUND OF THE INVENTION

Panels of gypsum wallboard which comprise a core of set gypsum sandwiched between two sheets of facing paper have long been used as structural members in the fabrication of buildings where the panels are used to form the partitions or walls of rooms, elevator shafts, stairwells, ceilings and the like.

In efforts to mitigate or overcome problems associated with the use of paper-faced gypsum wallboard in applications where moisture exposure is expected to occur, the prior art has approached the problem in various ways over the years.

One approach to the problem has been to treat the paper comprising the facing of the wallboard with a water-resistant material sometimes referred to as a water-repellant. Polyethylene emulsion is an example of a material that is used to treat paper facing to impart water-resistant characteristics. Such treatment is designed to deter delamination of the multi-ply paper facing by reducing the tendency of the paper to absorb water which is a chief cause of delamination and to deter water from penetrating through the paper to the gypsum and destroying the bond between the paper-facing and gypsum core.

Another approach to the problem has involved incorporating into the formulation from which the gypsum core is made a material that functions to impart improved water-resistant properties to the set gypsum core itself. Such an additive tends to reduce the water-absorbing tendency of the core and decrease the solubility characteristics of the set gypsum. Wax-asphalt emulsions and wax emulsions are examples of such additives.

Although improvements have been realized by the provision of gypsum wallboard prepared in accordance with these teachings, further improvements are still possible. Experience shows that even with such constructions the paper facing delaminates and the gypsum core erodes through the degrading action of moisture. The problem is particularly aggravated by warm water acting upon a gypsum core that includes either a wax emulsion or a wax-asphalt emulsion, commonly used water-resistant core additives. While cores containing such materials have relatively good water-resistant characteristics in the presence of water at room temperature, such characteristics start to fall off at temperatures in excess of 70° F. and tend to disappear in the presence of water having a temperature of about 100° F. or higher.

In another commercially successful approach, a structural panel comprising a water-resistant set gypsum core sandwiched between two porous fibrous mats is provided, see U.S. Pat. No. 4,647,496. The preferred form of mat is described as a glass fiber mat formed from fiberglass filaments oriented in random pattern and bound together with a resin binder. Such panels differ from conventional gypsum wallboard in that the fibrous mat is substituted for paper as the facing material(s) of the gypsum core. In such constructions, the set gypsum from the core extends at least part-way into the fibrous mat facer to form an integral attachment/bond between the gypsum and the mat.

Extensive outdoor testing has shown that glass mat-faced, water-resistant gypsum board of the type described in the aforementioned '496 patent has much better weathering characteristics, including water-resistant characteristics, than water-resistant gypsum board covered with water-resistant paper facing. In one of the more recent improvements of this technology, as described in U.S. Pat. No. 5,397,631, the fibrous mat-faced gypsum board is coated with a latex polymer. The coating, which acts as both a liquid and vapor barrier (vapor permeance of about 1.2 perms (ASTM E-96)), is formed from an aqueous coating composition comprising from about 15 to about 35 wt. % of resin solids, about 20 to about 65 wt. % of filler, and about 15 to about 45 wt. % of water, applied to obtain a solids loading of at least about 50 lbs. per 1000 sq. ft, such as about 110 lbs. per 1000 sq. ft. A preferred resin for use according to this patent is a latex polymer that has been sold by Unocal Chemicals Division of Unocal Corporation under the mark 76 RES 1018. The resin is a styrene-acrylic copolymer that has a relatively low film-forming temperature. The aqueous coatings composition formed from the resin is not applied to the fibrous mat-facing of the gypsum board until after the board has been prepared. The post-applied coating is dried effectively at oven temperatures within the range of about 300° to 400° F. If desired, a coalescing agent can be used to lower the film-forming temperature of the resin.

More recently, a coated fibrous mat-faced gypsum board of surprisingly effective moisture resistance, having a predominantly inorganic coating on the mat, was developed, see U.S. Published application Ser. No. 20020155282, which is incorporated herein by reference. The mat used to prepare the gypsum board was pre-coated with a predominately inorganic coating and the pre-coated fibrous mat was used as at least one of the facers in the manufacture of a gypsum board. Surprisingly, the coating on the pre-coated mat had sufficient porosity to allow water vapor to permeate through the mat during manufacture of the board, but provided the board with unexpectedly effective moisture resistance. Using a pre-coated mat to manufacture the board significantly simplified the manufacture of the board. The coating was comprised of a mineral pigment (pigmented filler material), an inorganic binder and a latex polymer binder. In particular, the coating comprised a dried (or cured) aqueous mixture of a mineral pigment; a first binder of a polymer latex adhesive and, a second binder of an inorganic adhesive. On a dry weight basis, the first polymer latex binder comprised no more than about 5.0% by weight of the coating, and the second inorganic binder comprised at least about 0.5% by weight, of the total weight of the coating.

The second inorganic binder preferably comprised an inorganic compound such as calcium oxide, calcium silicate, calcium sulfate, magnesium oxychloride, magnesium oxysulfate, or aluminum hydroxide. In one embodiment, the second binder was present as an inherent component in the mineral pigment, as in the case when the mineral pigment includes aluminum trihydrate, calcium carbonate, calcium sulfate, magnesium oxide, or some clays and sands. The ratio, by weight, of the mineral pigment to the polymer latex adhesive in the coating was generally in excess of 15:1.

Polymer latex adhesives identified for use in this board construction included styrene-butadiene-rubber (SBR), styrene-butadiene-styrene (SBS), ethylene-vinyl-chloride (EVCI), poly-vinylidene-chloride (PVdC), modified poly-vinyl-chloride (PVC), poly-vinyl-alcohol (PVOH), ethylene-vinyl-actate (EVA), and poly-vinyl-acetate (PVA). The polymer laxtex used in the commercial embodiment of this board construction was a styrene-butadiene rubber (SBR) latex.

While the board made in accordance with these teachings showed excellent water tolerance for interior applications, the board was not able to perform satisfactorily in exterior applications. It was subsequently determined after a long term exposure test that the degradation of the SBR resin from UV exposure contributed to the poor exterior performance of the board.

### BRIEF DESCRIPTION OF THE DRAWINGS

The objects, features, and advantages of the invention will be apparent from the following more detailed description of certain embodiments of the invention and as illustrated in the accompanying drawing. The drawing is highly schematic and is not necessarily to scale, emphasis instead being placed upon illustrating the features of the invention.

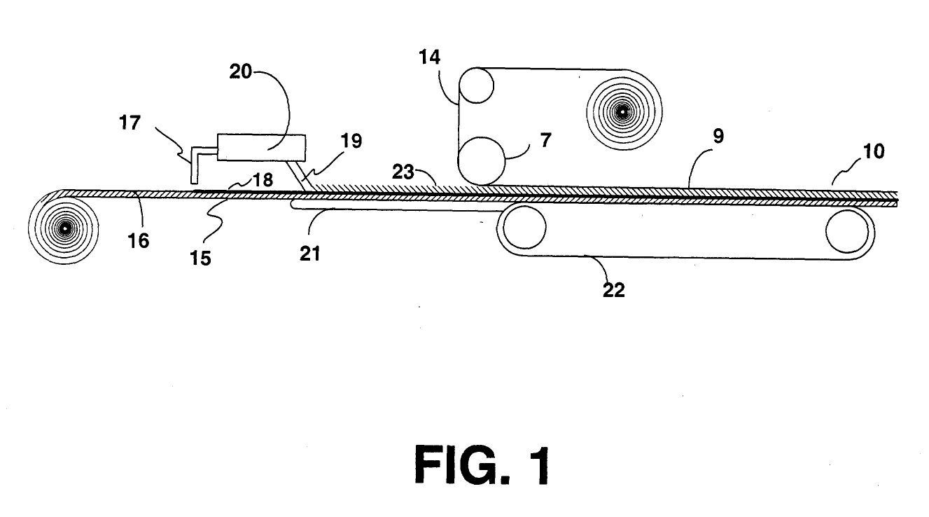

The sole FIGURE, FIG. 1, shows a highly schematic view of an apparatus for making the gypsum board of the present invention and the board being assembled thereon.

### DETAILED DESCRIPTION OF THE INVENTION

As shown in FIG. 1, a moisture-tolerant structural panel of the present invention 10 can be manufactured by enmeshing a set gypsum board core 23 with at least one, and preferably two fiber mats, 14 and 16, preferably both are predominately glass fiber mats. The surface of at least one of the mats (and optionally both of the mats) has been pre-coated with a dried (heat cured) coating (indicated by the numeral 15 in the sole figure) of an aqueous coating composition containing a combination (e.g., a mixture) of a mineral pigment or filler; an organic binder of a UV resistant polymer latex adhesive having a suitable level of hydrophobicity (a hydrophobic, UV resistant polymer latex) and, optionally a second binder of an inorganic adhesive. By “pre-coated” is meant that the mat has a dried, adherent coating of what was originally an aqueous coating composition, as hereinafter defined in more detail, applied to its surface before the mat is used to make the gypsum board of the present invention.

Not all UV resistant polymer latex adhesives are suitable for use in the present invention. Unless the polymer adhesive demonstrates a satisfactory level of hydrophobicity, as determined by an easily performed test, which is described in detail below, and also provides, in combination with the mineral pigment or filler and the optional inorganic adhesive, the desired level of porosity at the below-recited usage levels, also as determined by an easily performed test, which is described in detail below, the polymer adhesive is not suitable for use in the coating composition of the present invention for making the pre-coated fibrous mat.

As used throughout the specification and claims, the terms hydrophobic, hydrophobicity and the like are intended to embrace polymers which yield a three minute Cobb value, in the test of determining a Cobb value as detailed below, of below about 1.5 grams, and preferably below about 0.5 gram.

In any event, the pre-coated fiber mat used in the preparing the gypsum board of the present invention can be prepared by applying an aqueous coating composition containing the noted solid constituents to a fiber mat in an amount on a dry weight basis equivalent to at least about 40 lbs., more usually between about 45 and 100 lbs., per 1000 sq. ft. of mat. Normally, the dry coating is present in an amount equivalent to at least about 50 lbs. depending upon the thickness of the glass fiber mat.

Applicants have found certain UV resistant latex resins of the desired hydrophobicity and have determined that these resins are useful for making a pre-coated fibrous mat useful in ultimately making an improved gypsum panel particularly useful for exterior applications. Quite surprisingly, applicants have observed that mats coated with compositions made using such hydrophobic, UV resistant latex resins (polymers), within certain compositional constraints, are sufficiently porous to be used for making a gypsum board in accordance with the present invention and that such pre-coated fibrous mats produce a gypsum board having exceptional weathering characteristics.

The core of the gypsum board also preferably includes a water-resistant additive, and the coated mat-faced board has a weight equivalent of no greater than about 2500 lbs. per 1000 sq. ft. of board surface area (for a ½″ board).

Gypsum boards made with the pre-coated fibrous mat of the present invention have superior weathering characteristics, and accordingly, can be used effectively for indefinite periods of time as a stable substrate in outdoor applications involving extended exposure to the sun, prolonged water contact and high humidity.

In addition to providing improved performance under high humidity conditions, the fire resistance of glass fiber mat-faced gypsum boards of the present invention, in particular, also is enhanced by what is primarily an inorganic coating on the mat.

The gypsum core of the moisture tolerant structural panel of the present invention is basically of the type used in those gypsum structural products, which are known as gypsum wallboard, dry wall, gypsum board, gypsum lath and gypsum sheathing. The core of such a product is formed by mixing water with powdered anhydrous calcium sulfate or calcium sulfate hemi-hydrate (CaSO₄.½H₂O), also known as calcined gypsum to form an aqueous gypsum slurry, and thereafter allowing the slurry mixture to hydrate or set into calcium sulfate dihydrate (CaSO₄.2H₂O), a relatively hard material. The core of the product will in general comprise at least about 85 wt. percent of set gypsum, though the invention is not limited to any particular content of gypsum in the core.

The composition from which the set gypsum core of the structural panel is made can include a variety of optional additives, including, for example, those included conventionally in gypsum wallboard. Examples of such additives include set accelerators, set retarders, foaming agents, reinforcing fibers, and dispersing agents.

A preferred gypsum core of the present invention also includes one or more additives, which improve the water-resistant properties of the core. In particular, the coated fibrous mat-faced gypsum board for use in the present invention preferably comprises a gypsum core, which has water-resistant properties. The preferred means for imparting water-resistant properties to the gypsum core is to include in the gypsum composition from which the core is made one or more additives, which improve the ability of the set gypsum composition to resist being degraded by water, for example, to resist dissolution.

Examples of materials which have been reported as being effective for improving the water-resistant properties of gypsum products are: poly(vinyl alcohol), with or without a minor amount of poly(vinyl acetate); metallic resinates; wax or asphalt or mixtures thereof, usually supplied as an emulsion;

a mixture of wax and/or asphalt and also cornflower and potassium permanganate; water insoluble thermoplastic organic materials such as petroleum and natural asphalt, coal tar, and thermoplastic synthetic resins such as poly(vinyl acetate), poly(vinyl chloride) and a copolymer of vinyl acetate and vinyl chloride and acrylic resins; a mixture of metal rosin soap, a water soluble alkaline earth metal salt, and residual fuel oil; a mixture of petroleum wax in the form of an emulsion and either residual fuel oil, pine tar or coal tar; a mixture comprising residual fuel oil and rosin; aromatic isocyanates and diisocyanates; organopolysiloxanes, for example, of the type referred to in U.S. Pat. Nos. 3,455,710; 3,623,895; 4,136,687; 4,447,498; and 4,643,771; siliconates, such as available from Dow Corning as Dow Corning 772; a wax emulsion and a wax-asphalt emulsion each with or without such materials as potassium sulfate, alkali and alkaline earth aluminates, and Portland cement; a wax-asphalt emulsion prepared by adding to a blend of molten wax and asphalt an oil-soluble, water-dispersing emulsifying agent, and admixing the aforementioned with a solution of case in which contains, as a dispersing agent, an alkali sulfonate of a polyarylmethylene condensation product. Mixtures of these additives can also be employed.

A mixture of materials, namely, one or more of poly(vinyl alcohol), siliconates, wax emulsion and wax-asphalt emulsion of the aforementioned types, for example, also can be used to improve the water resistance of gypsum products, such as described in aforementioned U.S. Pat. No. 3,935,021, which is incorporated herein in its entirety.

Typically, the core of fibrous mat-faced gypsum board has a density of about 40 to about 55 lbs. per cu. ft., more usually about 46 to about 50 lbs per cu. ft. Of course, cores having both higher and lower densities can be used in particular applications if desired. The manufacture of cores of predetermined densities can be accomplished by using known techniques, for example, by introducing an appropriate amount of foam (soap) into the aqueous gypsum slurry from which the core is formed or by molding.

In accordance with the present invention, at least one surface of the core of the gypsum board is faced with a pre-coated fibrous mat. Based on testing, applicants have determined that the coating of the fibrous mat is basically impervious to liquid water. Surprisingly, the coating is sufficiently porous to permit water in the aqueous gypsum slurry from which the gypsum core is made to evaporate in its vaporous state therethrough during manufacture of the board. In this way, the coated mat is prepared in advance (pre-coated) and is used in making the mat faced gypsum board.

The pre-coated fibrous mat-faced gypsum board can be made efficiently, as is well known, by forming an aqueous gypsum slurry which contains excess water and placing the gypsum slurry on a horizontally oriented moving web of the pre-coated fibrous mat, with the coated mat surface oriented away from the deposited gypsum slurry. In a preferred embodiment, another moving web of fibrous mat, which optionally can also be the pre-coated fibrous mat, but for example also can be a glass mat, a mat made from a blend of glass and synthetic fibers, or a pre-treated mat, is then placed on the upper free surface of the aqueous gypsum slurry. Aided by heating, excess water evaporates through the pre-coated mat as the calcined gypsum hydrates and sets.

The fibrous mat(s) comprise(s) a fiber material that is capable of forming a strong bond with the set gypsum comprising the core of the gypsum board through a mechanical-like interlocking between the interstices of the fibrous mat and portions of the gypsum core filling those interstices. Examples of such fiber materials include (1) a mineral-type material such as glass fibers, (2) synthetic resin fibers and (3) mixtures or blends thereof. Glass fiber mats are preferred for making the pre-coated mat The mat(s) can comprise continuous or discrete strands or fibers and can be woven or nonwoven in form. Nonwoven mats such as made from chopped strands and continuous strands can be used satisfactorily and are less costly than woven materials. The strands of such mats typically are bonded together to form a unitary structure by a suitable adhesive. The fiber mat can range in thickness, for example, from about 10 to about 40 mils, with a mat thickness of about 15 to about 35 mils generally being suitable. The aforementioned fibrous mats are known and are commercially available in many forms.

One suitable fibrous mat for making the pre-coated mat used in the present invention is a fiberglass mat comprising chopped, nonwoven, fiberglass filaments oriented in a random pattern and bound together with a resin binder, typically a urea-formaldehyde resin adhesive. Fiber glass mats of this type are commercially available, for example, such as those which have been sold under the trademark DURA-GLASS by Manville Building Materials Corporation and those which have been sold by Elk Corporation as BUR or shingle mat. An example of such a mat, which is useful in preparing a coated mat for making gypsum board useful in structural building applications, is nominally 33 mils thick and incorporates glass fibers about 13 to 16 microns in diameter. A Johns Manville mat made with nominal 13 micron fibers (mat 7594) is suitable. Although certain structural applications may utilize a thicker mat and thicker fibers, a glass fiber mat nominally 20 mils thick, which includes glass fibers about 10 microns in diameter, is also suitable for use in the present invention. Mats suitable for making coated mat useful in the present invention have a basis weight, which is usually between about 10 and 30 lbs. per thousand square feet of mat surface area

Typically, but not exclusively, the glass fiber mats used as the base substrate of the pre-coated mat used in this invention are wet-formed into a continuous non-woven web of any workable width on a Fourdrinier-type machine. Preferably, an upwardly inclining wire having several linear feet of very dilute stock lay-down, followed by several linear feet of high vacuum water removal, is used. This is followed by a “curtain coater,” which applies the glass fiber binder and an oven that removes excess water and cures the adhesive to form a coherent mat structure.

The coating composition, which is applied to one, free surface of the above-described fiber mat for making the pre-coated mat for use in the present invention, comprises an aqueous combination of predominately a mineral pigment or filler; an organic binder of a hydrophobic, UV resistant polymer latex adhesive; and, optionally a second inorganic binder of an inorganic adhesive. On a dry weight basis of the two essential components (100%), the organic binder comprises at least about 1% and no more than about 17% by weight, with the balance being the inorganic, mineral pigment or filler. Optionally a second inorganic binder preferably comprising at least about 0.5% by weight, of the total weight of the dried (cured) coating, but no more than about 20% by weight of the coating also can be present. The weight ratio of the mineral pigment or filler to the polymer latex adhesive (organic) binder can be in excess of 15:1 and in some cases can be in excess of 20:1, but usually is at least about 5:1.

Suitable coating compositions for making the pre-coated mat useful in the present invention thus may contain, on a dry weight basis of the three noted components (100%), about 75 to 99 percent mineral pigment or filler, more usually about 83 to 95 percent mineral pigment or filler, about 0 to 20 percent inorganic adhesive, more usually about 0 to 10 percent and about 1 to 17 percent hydrophobic, UV resistant polymer latex adhesive (organic binder), more usually about 1 to 12 percent.

In addition to the two essential and one optional components, the aqueous coating composition will also include water in an amount sufficient to provide the desired rheological properties (e.g., viscosity) to the composition, which is appropriate for the chosen form of application of the composition for retention on the surface and within the interstices of the fibrous mat, and other optional ingredients such as colorants (e.g., pigments), thickeners or rheological control agents, defoamers, dispersants and preservatives. When used, the aggregate amount such other ingredients in the coating composition is typically in the range of 0.1 to 5% and generally is not more than about 2% of the three noted components.

Any suitable method for applying an aqueous coating composition to the fibrous mat substrate can be used for making the pre-coated mat, such as roller coating, curtain coating, knife coating, spray coating and the like, including combinations thereof. Following application of the aqueous coating composition to the mat the composition is dried (cured), usually by heat to form the pre-coated mat. The pre-coated mat made in accordance with these teachings is liquid impermeable, but does allow water vapor to pass through. Indeed, a surprising aspect of the present invention is that pre-coated mat made using the coating composition of the present invention, i.e., having as one essential component a hydrophobic, UV resistant polymer latex adhesive, is sufficiently porous to be used in making a gypsum board by the continuous process.

As noted above, a mineral pigment or filler comprises the major component of the coating composition. Examples of mineral pigments suitable for making coated mats useful in the present invention include, but are not limited to, ground limestone (calcium carbonate), clay, sand, mica, talc, gypsum (calcium sulfate dihydrate), aluminum trihydrate (ATH), antimony oxide, or a combination of any two or more of these substances.

The mineral pigment is usually provided in a particulate form. To be an effective mineral pigment for making a coated mat for use in this invention, the pigment should have a particle size such that at least about 95% of the pigment particles pass through a 100 mesh wire screen. Preferably, the pigment has most of, if not all of, the fine particles removed. It has been observed that the presence of an excess amount of fine particles in the coating composition negatively impacts the porosity of the pre-coated mat. A preferred mineral pigment is a limestone having an average particle size of about 40 μm. Such materials are collectively and individually referred to in the alternative as mineral pigments or as “fillers” throughout the remainder of this application.

The second essential constituent, the hydrophobic, UV resistant, polymer latex binder adhesive, includes, but is not limited to, polymers and copolymers containing units of acrylic acid, methacrylic acid (together referred to as (meth)acrylic acids)) , their esters (referred to together as ((meth)acrylates) or acrylonitrile.

Ordinarily these latexes are made by emulsion polymerization of ethylenically unsaturated monomers. Such monomers may include (meth)acrylic acid, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, and bomyl(meth)acrylate. Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters; and similar compounds.

The hydrophobic, UV resistant polymer latex binder adhesive is preferably based on a (meth)acrylate polymer latex, wherein the (meth)acrylate polymer is a lower alkyl ester, such as a methyl, ethyl or butyl ester, of acrylic and/or methacrylic acids, and copolymers of such esters with minor amounts of other ethylenically unsaturated copolymerizable monomers (such as stryrene) which are known to the art to be suitable in the preparation of UV resistant (meth)acrylic polymer latexes, can also be utilized. Another suitable co-monomer is vinyl acetate, which may be used as a co-monomer with, for instance, butyl acrylate in a ratio of 70/30 or smaller of the vinyl acetate to the butyl acrylate.

One particularly useful hydrophobic, UV resistant polymer latex binder adhesive is NeoCar® Acrylic 820. NeoCar® Acrylic 820 is an ultra-small particle size, hydrophobic latex available from Dow Chemical Company and is apparently made by copolymerizing a highly branched vinyl ester with an acrylate. Other suitable hydrophobic, UV resistant polymer latex binder adhesives include Glascol® C37 and Glascol® C44 available from Ciba Specialties Chemical Corporation; Rhoplex® AC-1034 available from Rohm & Haas and UCAR® 626 available from Dow Chemical Company.

As used throughout this specification and in the claims, the terms hydrophobic, hydrophobicity and the like are intended to embrace UV resistant polymers, which yield a three (3) minute Cobb value of below about 1.5 grams for the pre-coated fibrous mat. UV resistant polymers that exhibit a three (3) minute Cobb value of below about 0.5 grams are particularly preferred for making the pre-coated fibrous mat. The three minute Cobb value of a resin is determined by a simple procedure which is similar to TAPPI procedure T441. According to the procedure, a coated test mat is prepared by coating a standard glass mat with an aqueous coating formulation and dried at 230° F. (110° C.) for 20 minutes. The coating formulation is prepared by combining 70 parts by weight limestone having an average particle size of about 40 μm (GFP 102 available from Global Stone Filler Products or equivalent) with 17 parts by weight (dry solids basis) of the latex resin and blending thoroughly for 30 seconds. The aqueous formulation is applied to the mat using a simple knife applicator to obtain a dry basis weight of between about 22 grams of coating per sq. ft. on the glass mat (standard glass mat—Johns Manville mat 7594 or equivalent).

A 5.25 inches by 5.25 inches square sample of the coated mat is obtained, weighed and then secured in a 100 cm² Cobb ring. One hundred milliliters of warm (120° F. (49° C.)) water is poured into the ring as rapidly as possible and retained there for 2 minutes and 50 seconds. Then, the water is poured from the ring as quickly as possible (without contacting any other portion of the sample). At the three minute mark, a Couch roller is used with a sheet of blotting paper (rolled forward and backwards once) to remove excess moisture from the sample. The sample then is weighed and the increase in weight is recorded. The test is repeated once and the average of the two weight increase values is considered the three minute Cobb value for that sample. Again, only UV resistant latex resins exhibiting a three minute Cobb value of 1.5 gms or below in this test are suitable for use in the present invention.

As noted above, the latex resin also must satisfy a certain level of porosity when used in combination with a mineral filler in making a pre-coated glass mat. The porosity test is conducted with the same coated mat sample prepared in the manner outlined above. The test for porosity is a modification of the procedure of TAPPI T460, Gurley method for measuring the air resistance of paper. In this procedure, a sample of the coated mat (approximately 2 inches by 5 inches) is clamped between the 1 in² orifice plates of a Gurley Densometer, Model 4110. The inner cylinder is released and allowed to descend under only its own weight (i.e. by gravity alone) and the elapsed time (measured in seconds) between the instant the inner cylinder enters the outer cylinder of the apparatus until the 100 ml mark on the inner cylinder reaches (enters) the outer cylinder is recorded. The test then is repeated with the sample facing (oriented) in the opposite direction. The porosity, reported in seconds, comprises the average of the two replicates for each sample. A suitable resin exhibits a porosity of less than about 45 seconds, preferably less than about 20 seconds. At porosities of higher than about 45 seconds, the coated mat-gypsum core interface is at a much higher risk of delamination (i.e., blister formation) as the water vapors seek a path to escape during curing of the board. Preferably, the porosity is also more than about 2 seconds, so as to minimize bleedthrough of gypsum during board manufacture.

An optional component of the coating composition is an inorganic adhesive binder. Examples of inorganic adhesive binders which can be used in combination with the polymer adhesive latex binder(s) in the coating composition for making a pre-coated fibrous mat useful in this invention include, but are not limited to the following: calcium oxide, calcium silicate, calcium sulfate (anhydrous or hemi-hydrate), magnesium oxychloride, magnesium oxysulfate, and other complex inorganic binders of some Group IIA elements (alkaline earth metals), as well as aluminum hydroxide.

One example of a complex inorganic binder is common Portland cement, which is a mixture of various calcium-aluminum silicates. However, Portland cement cures by hydration, which can create a coating mixture with a short shelf life. Also, both the oxychloride and the oxysulfate of magnesium are complex inorganic binders, which cure by hydration. Coating formulations made with such inorganic adhesive binders must be used quickly or a tank containing the aqueous coating composition could set up in a short period of time.

The oxychlorides or oxysulfates of magnesium, aluminum hydroxide, and calcium silicate are only very slightly soluble in water, and are useful optional inorganic adhesive binders of this invention. Inorganic adhesive binders, which are quickly soluble in water, such as sodium silicate, may not be usable in coatings expected to be exposed to hot and/or high humid ambient conditions for long periods. One preferred inorganic adhesive binder for making a coated mat useful in this invention is quicklime (CaO). Quicklime does not hydrate in a coating mix, but cures by slowly converting to limestone, using carbon dioxide from the air. Quicklime is not (or only very sparingly) soluble in water.

Inorganic pigment or filler materials inherently containing some naturally occurring inorganic adhesive binder also can be used to make, and often are preferred for making the coated mat used in the present invention. Examples of such fillers, some listed with the naturally occurring binder, include (but are not limited to) the following: limestone containing quicklime (CaO), clay containing calcium silicate, sand containing calcium silicate, aluminum trihydrate containing aluminum hydroxide, cementitious fly ash and magnesium oxide containing either the sulfate or chloride of magnesium, or both. Depending on its level of hydration, gypsum can be both a mineral pigment and an inorganic adhesive binder, but it is only slightly soluble in water, and the solid form is crystalline making it brittle and weak as a binder. As a result, gypsum is not generally preferred for use as the optional inorganic adhesive binder.

Fillers, which inherently include an inorganic adhesive binder as a constituent and which cure by hydration, also advantageously act as flame suppressants. As examples, aluminum trihydrate (ATH), calcium sulfate (gypsum), and the oxychloride and oxysulfate of magnesium all carry molecules of water bound into their molecular structure. This water, referred to either as water of crystallization or water of hydration, is released upon sufficient heating, actually suppressing flames.

Low cost inorganic mineral pigments and fillers such with the properties of those described in the preceding paragraph, thus, may provide three (3) important contributions to the coating mixture: a filler; a binder; and, a fire suppressor.

In order for the pre-coated mat to be most useful in making the coated mat-faced gypsum board of the present invention, it is preferred that the coated mat be rolled into rolls of continuous sheet. As a result, the coated mat cannot be so stiff and brittle that it will break upon bending. To accomplish this objective, it appears that the inorganic adhesive binder content of the mat coating, when present in a formulation, should not exceed about 20% by weight of the total dry weight of the coating, and usually is less than about 10%. Rolls of a coated glass fiber mat suitable for making the coated mat faced gypsum board of the present invention has been obtained from Atlas Roofing Corporation as 50¾ inch Gold, Coated Glass Facer (CGF).

In the preferred embodiment, the amount and viscosity of the aqueous coating composition applied to the surface of the fibrous mat should be sufficient to embed the surface of the mat substantially completely in the coating, to the extent that on visual inspection (i.e., under no magnification) substantially no fibers can be seen as protruding through the subsequently dried coating. Additionally, the aqueous coating composition will penetrate at least partially into the interstices of the fibrous mat. The amount of coating required is dependent upon the thickness of the mat. Using a glass fiber mat nominally 33 mils thick (made using fibers of about 16 microns), the amount of coating when dried should be equivalent to at least about 40 lbs., preferably about 50 lbs. per 1000 sq. ft. of mat surface area; using a fiber glass mat nominally 20 mils thick (made with fibers of about 10 microns), a lesser amount of coating may be used. Although higher or lower amounts of coating can be used in any specific case, it is believed that, for most applications, the amount of coating will fall within the range of about 50 to about 120 lbs per 1000 sq. ft. of mat (dry solids basis). In particularly preferred form, applied to 33 mil mat of nominal 13 micron fibers, the dry coating should weigh about 45 to about 60 per 1000 sq. ft. of board.

With respect to the thickness of the coating, it is difficult to measure thickness because of the uneven nature of the fibrous mat substrate on which the coating is applied. In rough terms, the thickness of the coating usually should be at least about 6 mils, but when the glass mat is relatively thin and the coating is efficiently dried, a coating as thin as 3 mils may sometimes suffice. In general, the thickness normally need not exceed about 3040 mils.

The coating composition can be applied by any suitable means to the fibrous mat, for example, spray, brush, curtain coating, knife, roller coating and combinations thereof, with roller coating often being preferred. The amount of wet (aqueous) composition applied can vary over a wide range. It is believed that amounts within the range of about 70 or 100 to about 150 or 180 lbs. of aqueous coating composition per 1000 sq. ft. of mat will be satisfactory for most applications.

Once applied to the surface of the fibrous mat the aqueous coating composition is dried, typically in a drying oven, at a temperature and for a time sufficient to remove the water from the coating composition and coalesce the hydrophobic, UV resistant polymer latex adhesive to form an adherent coating, without degrading the coating or the mat. Suitable temperatures and times will be influenced greatly by the equipment being used and can be obtained by those skilled in the art using routine experimentation.

The moisture tolerant structural panels of this invention comprising a pre-coated fibrous mat-faced gypsum board can be made utilizing an existing, manufacturing line for gypsum wallboard as illustrated in FIG. 1. In conventional fashion, dry ingredients from which the gypsum core is formed are pre-mixed and then fed to a mixer of the type commonly referred to as a pin mixer 20. Water and other liquid constituents, such as soap, used in making the core are metered into the pin mixer where they are combined with the desired dry ingredients to form an aqueous gypsum slurry. Foam (soap) is generally added to the slurry in the pin mixer to control the density of the resulting core.

The gypsum slurry is dispersed through one or more outlets from the mixer onto a moving sheet (fibrous mat) 16, which is indefinite in length and is fed from a roll thereof onto a forming table 21 and advanced by conveyor 22. The sheet 16 includes a coating 15 on what constitutes the bottom surface of the sheet as fed to the forming table. As described above, the coating comprises a dried aqueous mixture of a mineral pigment; an organic binder comprising a hydrophobic, UV-resistant polymer latex adhesive; and, optionally a second binder comprised of an inorganic adhesive.

One stream of gypsum slurry may be discharged through outlet 17 to provide a relatively thin layer of aqueous calcined gypsum slurry 18 on the non-coated surface of sheet 16. The thin layer of gypsum slurry 18 is somewhat denser than the aqueous slurry of gypsum that is used to form the main portion of the core of the gypsum board (main core slurry discharged through outlet 19 to form gypsum slurry layer 23). This higher density region of the core, penetrates into the interstices of the fibrous mat and helps to form a strong bond between the lower density portion of the core and the pre-coated mat facer. Typically, the slurry used to form the thin layer (18) is about 18-20% more dense than the density of the slurry (23) used to form the main portion of the core.

In this illustrative embodiment, sheet 16 thus forms one of the facing sheets of the gypsum board. In preferred form, the sheet is the pre-coated fibrous mat of the type described above useful in accordance with the present invention. As noted above, the pre-coated mat is fed with the coated side facing away from the gypsum slurry. The slurry (preferably denser slurry 18) penetrates sufficiently into and through the thickness of the pre-coated glass mat, on the back-side, or non-coated side of the mat, to form a bond between the subsequently set gypsum, the fibrous mat and the dried adherent coating previously applied to the fibrous mat. Thus, on setting, a strong adherent bond is formed between the set gypsum and the pre-coated fibrous mat. In part because of the coating on the surface of the mat, the slurry does not penetrate completely through the mat.

As is common practice in the manufacture of conventional paper-faced gypsum board, the two opposite edge portions of the sheet 16 are progressively flexed upwardly from the mean plane thereof and then turned inwardly at the margins as to provide coverings for the edges of the resulting board. One of the benefits of the pre-coated mat used in connection with the present invention is that it has shown sufficient flexibility to form acceptable board edges

In a preferred embodiment of the invention, another fibrous mat 14, also supplied in roll form, is taken from the roll and fed around a roller 7 onto the top of the gypsum slurry 23 to form facing sheet 9, thereby sandwiching the gypsum slurry (core) between the two moving glass fiber sheets. The fibrous mats 16 and 14 thus form facings on the set gypsum core that is formed from the gypsum slurry to produce the gypsum board with opposite fibrous mat facers. Mat 14 is preferably one made from a blend of glass fibers and polyester fibers as described in U.S. Pat. No. 5,883,024. One source of such a mat is Johns Manville mat 8802. The mat also could be a standard glass fiber mat, or a treated, or coated glass mat, or a treated or coated glass-synthetic fiber blend mat. The mat 14 is applied to the top of the gypsum slurry. Thus, as above, a strong bond also is formed between this mat and the gypsum core as previously described.

Conventional shaping rolls and edge guiding devices (not shown) typically are used to shape and maintain the edges of the composite until the gypsum has set sufficiently to retain its shape. After the (top) fibrous mat 14 is applied, the “sandwich” of fibrous mats and gypsum slurry can be pressed to the desired thickness between plates (not shown). Alternatively, the fibrous mats and slurry can be pressed to the desired thickness with rollers or in another manner. The continuous sandwich of slurry and applied facing materials then is carried by conveyor(s) 22. Slurry 23 sets as it is carried along.

Although improvements can be realized by the use of a gypsum core which has but one of its surfaces faced with the pre-coated fibrous mat as described herein, it is believed that, for some applications, it may be advantageous to manufacture board having both surfaces faced with the pre-coated fibrous mat. Fibrous mat-faced gypsum board and methods for making the same are known, for example, as described in aforementioned U.S. Pat. No. 4,647,496 and in Canadian Patent No. 993,779 and U.S. Pat. No. 3,993,822. The weight of the board (nominal ½″ thickness) usually should not exceed about 2500 lbs. per 1000 sq. ft. Typically, the board will weigh at least about 1900 lbs. per 1000 sq. ft.

The ability of the pre-coated fibrous mat used in the present invention to pass water vapor therethrough is an important feature of the present invention and is such that the drying characteristics of the board are not substantially altered relative to a board faced with conventional paper facing. This means that industrial drying conditions typically used in continuous gypsum board manufacture also can be used in the manufacture of pre-coated mat-faced board of the present invention. Exemplary drying conditions include dryer (oven) temperatures of about 200° to about 700° F., with drying times of about 30 to about 60 minutes, at line speeds of about 70 to about 400 linear feet per minute.

Board of the present invention can be used effectively in many outdoor applications in addition to those previously mentioned. For example, the coated board can be used in applications of the type where conventional gypsum sheathing is applied as a support surface for overlying materials such as wood siding, stucco, synthetic stucco, aluminum, brick, including thin brick, outdoor tile, stone aggregate and marble. Some of the aforementioned finishing materials can be used advantageously in a manner such that they are adhered directly to the coated board. The board can be used also as a component of exterior insulating systems, commercial roof deck systems, and exterior curtain walls. In addition, the board can be used effectively in applications not generally involving the use of paper-faced gypsum board. Examples of such applications include walls associated with saunas, swimming pools, gang showers, or as a substrate or component of a secondary weather barrier.

The examples that follow are illustrative, but are not to be limiting of the invention.

### EXAMPLE 1

A pre-coated fibrous mat can be prepared by first preparing the
following coating composition.

| Ingredients | Amounts, wt. % |
|---|---|
| Aqueous acrylic latex (45% solids) | 18.7 |
| (NeoCar ® 820) | |
| Limestone | 65.3 |
| (GFP 102 from Global Stone Filler Products) | |
| Ethyl hydroxyethyk cellulose thickener/stabilizer | 0.04 |
| Bermocoll 230FQ | |
| Acrylate thickeners | 0.19, 0.19 |
| Paragum 501, 109 | |
| Colorant | 0.47 |
| Englehard W 1241 | |
| Ammonia | 0.37 |
| Added water | 14.74 |

The aqueous coating composition can be applied by roller or knife coater (or a combination thereof) to Johns Manville 7594 fiberglass mat at an application rate of about 30 grams per square foot (about 65 pounds per 1000 square feet). The wet coating composition can be dried in a conventional drying oven. The dried basis weight of the coating should be about 22 grams per square foot (about 50 pounds per 1000 square feet). Upon visual inspection, the coating should completely cover the glass mat and no fibers should be seen protruding through the mat. A pre-coated mat made in accordance with this example is suitable for making gypsum board in accordance with the following example.

### EXAMPLE 2

A pre-coated fiberglass mat was obtained from Atlas in roll form (50¾ Inch Gold coated glass facer) and was used to prepare gypsum board panels. The coated mat was prepared from an uncoated mat having a basis weight of about 2 pounds per 100 square feet. The substrate mat was composed of glass fiber filaments, nominally 13 microns in diameter, oriented in a random pattern bonded together by a urea-formaldehyde adhesive resin. The pre-coated mat had a thickness of about 30 mils and a porosity of about 7 seconds.

Continuous length board was made from a gypsum slurry containing about 55% percent by weight of gypsum hemi-hydrate and the pre-coated Atlas mat on a conventional wallboard machine. The slurry was deposited on one continuous sheet of the coated mat, which was advanced at a rate of 180 linear feet per minute, sufficient to form a ⅝th inch thick board, while a continuous sheet of Johns Manville 8802 fibrous mat was deposited onto the opposite surface of the gypsum slurry. Drying of the gypsum board was accelerated by heating the composite structure in an oven at about 600° F. for about thirty minutes and until the board is almost dry and then at about 250° F. for about fifteen minutes until it is dried completely. The density of the coated mat-faced board was determined to be about 47 lb. per cu. ft.

The coated mat-faced gypsum board made in accordance with the present invention is capable of resisting for indefinite periods of time attack by water, both in indoor and outdoor applications, and to offer significantly enhanced fire resistance. In summary, it can be said that the improved gypsum-based product of the present invention has water-tolerant properties which are at least equal to or better than prior art products, and that this is achieved in a product that is obtained in a product that is as light as and more economical to make than prior art products.

It will be understood that while the invention has been described in conjunction with specific embodiments thereof, the foregoing description and examples are intended to illustrate, but not limit the scope of the invention. Unless otherwise specifically indicated, all percentages are by weight. Throughout the specification and in the claims the term “about” is intended to encompass + or −5%.

Other aspects, advantages and modifications will be apparent to those skilled in the art to which the invention pertains, and these aspects and modifications are within the scope of the invention, which is limited only by the appended claims.

I/We claim:

1. A moisture-tolerant structural panel made by
(1) contacting a gypsum slurry for forming a gypsum core with
(2) a pre-coated mat comprising fibers, having a coated side and a non-coated side, to adhere the non-coated side of said coated mat to said gypsum core;
the pre-coated mat having a coating comprising a combination of (i) a mineral pigment, (ii) a hydrophobic, UV resistant polymer latex adhesive binder and optionally (iii) an inorganic adhesive binder, and
(3) allowing the gypsum slurry to harden to form said gypsum core,
wherein said pre-coated mat has a porosity which allows water to evaporate through said pre-coated mat from the gypsum core during preparation of the panel.

2. A panel according to claim 1 wherein said mat contains glass fibers nominally about 10 to 16 microns in diameter.

3. A panel according to claim 2 in which said mat, in the absence of said coating, has a basis weight of 10 to 30 pounds per 1000 square feet.

4. A panel according to claim 1 having a density of 40 to 55 pounds per cubic foot.

5. A panel according to claim 1 wherein the coating weighs about 40 to 120 pounds per 1000 square feet of mat.

6. A panel according to claim 5 wherein the mineral pigment comprises from about 75 to 99 weight percent of the coating, the inorganic adhesive binder comprises from about 0 to 20 weight percent of the coating and the hydrophobic, UV resistant polymer latex adhesive binder comprises from about 1 to 17 weight percent of the coating.

7. A panel according to claim 6 wherein the mineral pigment comprises from about 83 to 95 weight percent of the coating, the inorganic adhesive binder comprises from about 0 to 10 weight percent of the coating and the hydrophobic, UV resistant polymer latex adhesive binder comprises from about 1 to 12 weight percent of the coating.

8. A panel according to claim 6 wherein said combination was applied to a surface of a fibrous mat as an aqueous coating composition and dried to form said pre-coated mat, said aqueous coating composition upon drying and setting, covering said fibrous mat to the extent that substantially none of the fibers of said mat can be seen protruding from said coating.

9. A moisture-tolerant structural panel made by
(1) contacting a gypsum slurry with two fibrous mats for forming a set gypsum core between said two fibrous mats, wherein a free surface of one of said mats is pre-coated with a combination of (i) a mineral pigment, (ii) a hydrophobic, UV resistant polymer latex adhesive binder and optionally (iii) an inorganic adhesive binder, said combination having been applied to said free surface as an aqueous coating composition and dried to form a pre-coated fibrous mat, said combination containing no more than about 17 wt. % polymer latex adhesive solids, and said aqueous coating composition upon drying and setting, forming a dried coating on said one mat to the extent that substantially no fibers of the free surface said one mat can be seen protruding from said coating, and
(2) allowing the gypsum slurry to harden to form said set gypsum core,
wherein the set gypsum core includes a water-resistant additive in an amount sufficient to improve water-resistant properties of said core, and wherein said pre-coated mat has a porosity which allows water to evaporate through said pre-coated mat from the gypsum core during preparation of the panel.

10. A panel according to claim 9 wherein said aqueous coating composition comprises (1) on a solids basis at least about 75% by weight of the mineral pigment, from 0 to 20% by weight of the inorganic adhesive binder and from about 1 to 12% of the hydrophobic, UV resistant polymer latex adhesive binder and (2) water.

11. A panel according to claim 10 wherein said aqueous coating composition includes about 0.1 to about 5 wt. % of one or more additives selected from the group consisting of a thickener, dispersant, colorant, defoaming agent and preservator

12. A panel according to claim 9 wherein said combination is coated on said pre-coated mat in an amount equivalent to no more than about 100 lbs. per 1000 sq. ft. of the mat.

13. A panel according to claim 12 in which said mat, in the absence of said coating, has a basis weight of 10 to 30 pounds per 1000 square feet.

14. A panel according to claim 10 wherein the amount of said water-resistant additive is at least about 0.2 wt. %.

15. A panel according to claim 10 wherein the amount of said water-resistant additive is about 0.3 to about 10 wt. %.

16. A panel according to claim 14 wherein said additive is selected from the group consisting of a wax emulsion, a wax-asphalt emulsion, poly(vinyl alcohol), a polysiloxane , a siliconate and mixtures thereof.

17. A panel according to claim 6 or 10 wherein the hydrophobic, UV resistant polymer latex adhesive binder of said combination consists essentially of a (meth)acrylic or (meth)acrylate polymer or a (meth)acrylic or (meth)acrylate copolymer.

18. The panel of claim 10 having a ½″ board weight not exceeding about 2,500 lbs. per 1,000 cu. ft.

19. The panel of claim 10 wherein said one of the fibrous mats consists essentially of glass fibers and the other fibrous mat consists essentially of a blend of glass fibers and synthetic fibers.

20. A gypsum board comprising a set gypsum core adhered between two fibrous mats, wherein a free surface of one of said mats is pre-coated with a coating comprising a combination of (i) a mineral pigment, (ii) a hydrophobic, UV resistant polymer latex adhesive binder and optionally (iii) an inorganic adhesive binder, and wherein said pre-coated mat has a porosity which allows water to evaporate through said pre-coated mat from the gypsum core during preparation of the board.

21. The gypsum board of claim 20 wherein said combination is applied to said free surface as an aqueous coating composition, said aqueous coating composition upon drying and setting, forming a dried coating on said one mat to an extent that substantially no fibers of said mat can be seen protruding from said dried coating.

22. The gypsum board of claim 20 wherein the mineral pigment comprises from about 75 to 99 weight percent of the coating, the inorganic adhesive binder comprises from about 0 to 20 weight percent of the coating and the hydrophobic, UV resistant polymer latex adhesive binder comprises from about 1 to 17 weight percent of the coating.

23. The gypsum board of claim 22 wherein the mineral pigment comprises from about 83 to 95 weight percent of the coating, the inorganic adhesive binder comprises from about 0 to 10 weight percent of the coating and the hydrophobic, UV resistant polymer latex adhesive binder comprises from about 1 to 12 weight percent of the coating.

24. The gypsum board of claim 20, 21, 22 or 23 wherein the hydrophobic, UV resistant polymer latex adhesive binder of said combination consists essentially of a (meth)acrylic or (meth)acrylate polymer or a (meth)acrylic or (meth)acrylate copolymer.
